(19) United States
(12) Patent Application Publication
(10) Pub. No.: US 2008/0104811 A1
(43) Pub. Date: May 8, 2008

(54) Tension limited ratchet buckle for securing cargo

(76) Inventors: Ward C. Burrows, Pasadena, CA (US); Howard Thomas Knox, Erlanger, KY (US)

Correspondence Address: EDWARD A SOKOLSKI, 3868 CARSON STREET, 105, TORRANCE, CA, 90503, US

(21) Appl. No.: 11/650,228

(22) Filed: Jan. 5, 2007

Related U.S. Application Data
(60) Provisional application No. 60/858,061, filed on Nov. 8, 2006.

(51) Int. Cl. B25B 25/00

(52) U.S. Cl. 24/68 CD

(57) ABSTRACT

A ratchet buckle has a mandrel around which a strap for securing cargo or the like is wound. A handle assembly is connected to the mandrel through ratchet wheels and is manually driven up and down to tighten the strap. The handle assembly is divided into an outer section, which is manually driven up and down, and an inner section, which is connected to the mandrel. The two sections are connected together so that the driving of the outer section effects driving of the inner section. A spring operates to urge detents on the inner section into the ratchet wheels. Torsion springs are connected between the inner and outer handle sections. The inner and outer sections as well as the torsion springs are supported on a bolt and interconnected by lugs on one section and slots in the other section, which are driven together by spring washers. When the tension on the strap exceeds a predetermined level, the force of all of the springs is exceeded and the inner handle section is driven out of torsional engagement with the outer handle section.

This application is based on Provisional application No. 60/858.061 filed Nov. 8, 2006

### BACKGROUND OF THE INVENTION

1. Field of the Invention This invention relates to a device for securing cargo on a vehicle and more particularly to such a device utilizing a ratchet buckle, which secures a strap over the cargo.

2. Description of the Related Art

Ratchet buckles are commonly used to secure loads being transported in vehicles. Prior art such buckles are described in the following patents: U.S. Pat. No. 4,185,360 issued on Jan. 29, 1980 to Prete; U.S. Pat. No. 5,205,020 issued Apr. 27, 1993 to Kamper; U.S. Pat. No. 4,324,023 issued Apr. 13, 1982 to Prete; U.S. Pat. No. 4,154,427 issued May 15, 1979 to Hofmann; U.S. Pat. No. 4,199,182 issued Apr. 22, 1980 to Sunesson; Japanese publication no. 10218224 to Nippon Seiko, et. al. filed Jan. 31, 1997 and Japanese publication no. P2002-106645A to Ankura Japan Co. Ltd, filed Oct. 4, 2000.

Prior art ratchet buckles while they generally provide reliable and sturdy load securing have one significant drawback. This is related to the fact that a ratchet buckle can impose a very high pre-load on the securing strap and the cargo, which is often high enough to damage the cargo or even rip the mounting points off of the walls of the mounting compartment.

To alleviate this problem, tension limited ratchet buckles have been developed which employ a detented handle containing a pivot point with spring-loaded detents. Once the force on the handle is sufficient to overload the detents, the detents are forced apart, permitting the handle to break away from a latch plate, which drives the ratchet wheel with a resulting loss of leverage making further tensioning impossible. A ratchet buckle of this type is described in the above-cited Japanese publication no. 10-218224.

While this prior art device operates to achieve the basic desired end results, it has several drawbacks. The first of these is that the release of the detents occurs very suddenly and under a considerable load. This causes violent motion of the handle, which can injure personnel. In addition, the force needed to restrain the load requires large detents backed by a very powerful spring. The high contact forces involved create a great deal of wear on the detents so that their service life is shortened. Also, the wear on the detents results in their drifting from their set points. The dependence on the breakaway point of the detents results in great reliance on the tension on the bolt holding the assembly together in that greater tension causes greater compression of the disc springs that drive the detents. This shifts the point set for breakaway. Additionally, manufacturing variations can result in two buckles of similar design having widely different breakaway points.

### SUMMARY OF THE INVENTION

The device of the present invention overcomes the above-indicated shortcomings of the prior art by dividing the handle assembly for driving the mandrel into two sections, an outer section which has a bar thereon for use in manually driving the handle and an inner section which is connected to the mandrel through a spring biased latch detents which engagea ratchet wheels attached to the mandrel. The two sections are pivotally interconnected. Torsion springs are connected between the outer handle section and the inner handle section to provide high-level torsion on the outer handle section, which retains this handle section in its normal position. A plurality of lugs are formed on the inside walls of the outer handle section, in a generally circular formation. Slots, which are in mating engagement with the lugs, are formed on opposing outer walls of the inner handle section. The lugs are urged into mating engagement with the slots by spring washers and the inward force of the sidewalls of the outer handle section while tensioning a strap with the buckle. When the tension of the strap reaches a predetermined limit, a torque is generated about the handle, which exceeds the resistance torque of the torsion springs and the retaining force between the slots and the lugs. This results in the release of the outer handle section from its retained position on the inner handle section so that it hinges at the joints there between to indicate the preset maximum load has been reached.

When manual force is removed from the handle, the torsion springs force the central breakaway joint in the handle to move back to its at rest position.

Some of the resistance of the hinge joint at the mid point of the handle is a combination of that of the torsion springs and the detents which is not subjected to the high forces of prior art designs. As a result, there is reduced wear on the detents in the device of the present invention.

Further, the set point of the handle is maintained by means of spring washers, which keep the set point more consistent. Further, when the detents disengage from the ratchet wheels, there is a noticeable but not large motion, with the torsion springs still holding the outer handle section. As the deflection of the outer handle section increases, the force exerted by the torsion springs also increases, the increasing load on the torsion springs slowing the outer handle section to a stop rather than permitting it to move rapidly which could cause injury.

### REFERRING NOW TO THE DRAWINGS

FIG. 1 is a top perspective view of a preferred embodiment of the invention;

FIG. 1A is a side elevational view showing the handle moving to its upright position;

FIG. 1B is a top perspective view showing the handle under high tension and in the process of breaking away;

FIG. 2 is a partial cross-sectional view taken along the plane indicated by 2-2 in FIG. 1;

FIG. 3 is a top perspective exploded view showing the details of the torsion spring assembly of the embodiment of FIG. 1;

FIG. 4 is an exploded perspective view illustrating the details of the connection between the ratchet handle portions.

FIG. 5 is a cutaway perspective view illustrating the torsion spring and the attachment of its support bar to the handle;

FIG. 6 is a cross-sectional view taken along the plane indicated by 6-6 in FIG. 5; and

FIG. 7 is a cross sectional view showing one of the lugs and slots on the portions of handle separated from each other.

### DETAILED DESCRIPTION OF THE INVENTION

Referring to the FIGS, the ratchet handle 11 has an outer section 11a and an inner section 11b, which are pivotally supported on bolt 12. The outer section 11a of the ratchet handle is urged towards a downward position by torsion coil springs 13a and 13b, which run around and are fixedly retained on bolt 12. One of the ends of each of the torsion springs abuts against post 14, which is fixedly attached to outer handle section 11a. The other ends of the torsion springs abut against post 27, which is fixedly attached to inner handle section 11b. Bar 18 runs between the opposite walls of handle section 11a. This bar permits the handle section 11a to pivot slightly on bolt 12 relative to handle section 11b on bolt 12 between the edge portions of grooves 11h formed in each of the ends of the handle portion 11b. This provides a stop to the rotation of the outer section 11a relative to the inner section 11b so that the handle is in a straight shape when no pressure is applied to handle bar 11c.

Handle Bar 11c mounted on the outer ends of outer handle section 11a serves as an arm for use by he operator in tightening strap 25. Latch plate 16 is slidably attached to the ratchet handle section 11b in slot 30. The handle section 11b is pivotally supported on the main frame 15 of the device on mandrel 26, which is pivotally supported on the main frame. Latch plate 16 has a pair of extensions 16a on the opposite sides thereof, these extensions forming detents engaging the ratchet elements 17a of ratchet wheels 17. The ratchet elements 17a are each separated from each other by a predetermined angular distance. The extensions 16a of the latch plate 16 are driven into engagement with the ratchet elements of the ratchet wheels by coil spring 21, which abuts against slotted opening 11i formed in inner handle section 11b on one end and engages latch plate 16 on the other end.

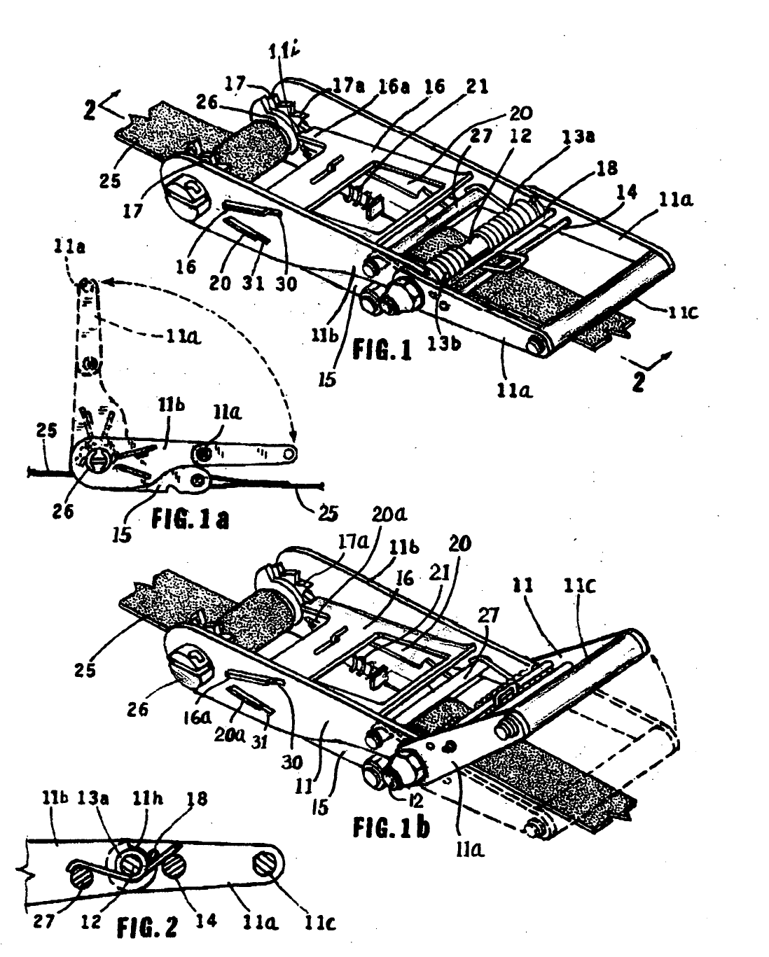

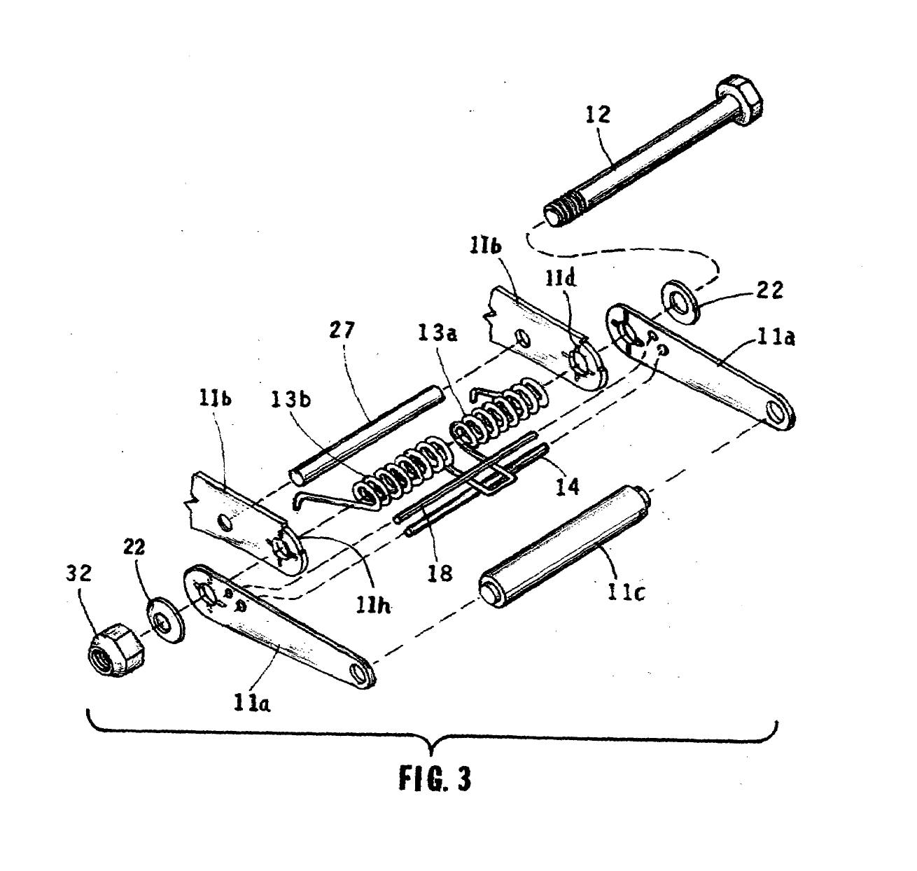

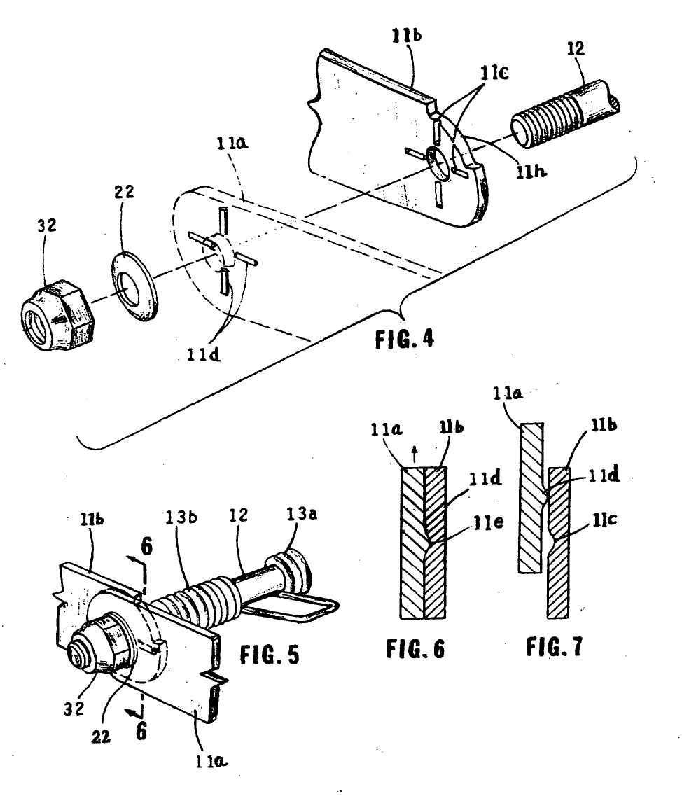

AS shown in FIGS. 3 and 4, spring washers 22 are installed in the assembly including bolt 12. As can be seen in FIG. 1, strap 25, which secures the cargo, is wound around mandrel 26, which is pivotally supported on frame 15, the ratchet wheels 17 being fixedly attached to the mandrel.

Referring to FIG. 3-7, the details are illustrated of the mechanism for controlling the release of the sections of the ratchet handle 11a and 11b from driving connection with each other. As already noted, bolt 12 provides the support for the torsion springs 13a and 13b, as shown in FIG. 3, and joins the ratchet handle sections 11a and 11b to each other. This joinder of the handle sections to each other is achieved by means of bolt 12 and nut 32. The overall assembly can best be seen in FIGS. 1, 3 and 4. FIG. 4 shows only one side of the ratchet handle portions, the opposite side being the same.

Formed on the inner surfaces of the end wall portions of handle section 11a are a plurality of lugs 11d, which as shown, are four in number on each sidewall of the handle section and are equally spaced from each other in a generally circular formation. Formed in the end wall portions of handle section 11b are pluralities of slots 11e, which as shown are four in number on each side and equally spaced from each other in a generally circular configuration. At various rotatable positions of the outer handle section 11a, the lugs 11d will be opposite the slots 11e and will insert therein to provide a retaining torque between handle sections 11a and 11b.

The operation of the device is as follows: With normal tension on the strap, the ends 16a of the latch plate 16 are maintained in engagement with the ratchet wheel so that upward movement of both sections of the handle will drive the ratchet wheels to tighten the strap as shown in FIG. 1A. With downward movement, the ratchet wheels will be held in place by the end portions 20a of latch plate 20, these end portions being inseerted in slots 31 formed in frame 15. As shown in FIG. 1B, when the tension of the strap reaches a predetermined limit, the force on the handle bar portion 11a will produce a torque about the bolt 12 which will exceed the resistance torque of springs 13a and 13b and the retaining torque between lugs 11d and slots 11e. When this occurs, the lugs will disengage from the slots, countering the force created by spring washers 22 and the inward flexibility of the sides of handle 11 portion 11a. This will allow the outer handle section 11a to rotate relative to the inner section 11b, thereby indicating to the user that there is maximum strap tension

Bolt 12 preferably has a sleeve installed over it (not shown) to provide friction to hold the springs in place. Bolt 12 is not only used to hold the assembly in place but also can be used to adjust the level of the breakaway of force required by its tightening or loosening.

It is to be noted that some of the basic construction of the device of the present invention is to be found in the prior art cited which in incorporated herein by reference.

While the invention has been described and illustrated in detail it is to be noted that this is intended by illustration and example only and not by way of limitation, the spirit and scope of the invention being limited by the terms of the following claims.

We claim:

1. A ratchet buckle device having a strap for retaining cargo to be held in place,: said strap being wound around a mandrel with ratchet wheels coupled thereto, said device comprising
a handle assembly including an outer section with a bar at its outer end for use in manually driving said handle assembly and an inner section connected at its inner end to said mandrel;
means for torsionally holding said handle assembly sections together in a substantially linear configuration;
first spring means connected between the inner and outer handle sections for retaining said sections in a downward position, and
second spring means for retaining said inner handle section in engagement the said ratchet wheels;
whereby when the tension on said strap reaches a predetermined level which exceeds the torsion of said first spring means, said inner and outer handle sections are torsionally disconnected from each other at the joint there between.

2. The device of claim 1 wherein said fist spring means comprises a pair of torsion springs and further including a bolt around which said springs are installed.

3. The device of claim 2 wherein said bolt interconnects said handle sections

4. The device of claim 1 wherein said means for holding said handle sections together comprises lugs on one of said sections and slots on the other of said sections, said lugs fitting within said slots in mating engagement therewith.

5. The device of claim 4 and further including a spring washer for driving said lugs and slots into engagement with each other.

6. The device of claim 1 and further including means for permitting limited pivotal motion between the inner and outer handle sections.

7. The device of claim 6 wherein said means permitting limited pivotal motion between the inner and outer handle sections comprises a bar running between the opposite sides of said outer handle section and grooves formed in the sides of said inner handle section, said bar being fitted into said grooves.

8. In a ratchet buckle having a mandrel around which a strap is wound, said strap running over cargo to be secured in place, said mandrel being rotatably driven by ratchet wheels and a handle assembly coupled to said ratchet wheels for manually driving said ratchet wheels, the improvement comprising:
said handle assembly being divided into a an outer section and inner section,
said outer handle section having a bar thereon for use in manually driving said handle assembly,
said inner handle section being coupled to said ratchet wheels,
means for torsionally coupling said inner and outer handle sections together,
first spring means connected between said inner and outer handle sections for retaining the outer handle section in a downward direction; and
second spring means for driving said inner handle section into engagement with said ratchet wheels;
whereby when the torsion on said strap reaches a predetermined level which exceeds the torsion of both of said spring means, the inner and outer handle sections are torsionally disengaged from each other.

9. The ratchet buckle of claim 8 wherein said means for removably coupling said inner and outer handle sections together comprises a bolt, said first spring means comprising a torsion spring which is installed on said bolt.

10. The ratchet buckle of claim 9 wherein said means for removably coupling said inner and outer handle sections comprises lugs on one of said sections and slots on the other of said sections, said lugs being fitted into said slots in mating engagement therewith.

11. The ratchet buckle of claim 10 and further including a spring washer which abuts against said outer handle section opposite said lugs and slots, said washer driving said lugs and slots into engagement.
